(19) United States
(12) Patent Application Publication
(10) Pub. No.: US 2011/0283506 A1
(43) Pub. Date: Nov. 24, 2011

(54) Massive gulf of Mexico oil spill enclosure

(76) Inventor: William Redvers Belisle, New Orleans, LA (US)

(21) Appl. No.: 12/800,647

(22) Filed: May 20, 2010

(51) Int. Cl. B23P 17/00

(52) U.S. Cl. 29/428

(57) ABSTRACT

A massive enclosure to enclose the large majority of the oil spill in the Gulf of Mexico is presented. The 1×10⁻⁵ to 1×10⁵ feet vertical height device is made of corrosion-resistant titanium, treated stainless steel, and other metal and may also include flexible oil-resistant materials including plastics, aluminum, glass, alloys, and some metals. The circular or rectangular shaped enclosure is open in the middle for the positioning of the Gulf of Mexico oil spill and has outer edges ranging in width of 0.0001-1,000 feet. The outer edges of the enclosure include a semi-permeable membrane contacting the oil spill and Gulf water in the center of the enclosure and a chemical processing unit immediately adjacent to the semi-permeable membrane and between the membrane and the enclosure titanium, treated stainless steel, and other metal casing. The massive enclosure immobilizes the Gulf of Mexico oil spill, greatly reduces the potential impact of the oil spill on the Gulf coast and contains the oil spill for oil collection, transportation and treatment.

### CROSS-REFERENCE TO RELATED APPLICATIONS

1. Popa, M. A., Monforton, R. J., Plank, D. W., Devries, J. W. 2010. “Oil resistant packaging”, (U.S. Pat. No. 7,713,561).
2. Garcia, Z., 2007. “Oil spill collection device”, (U.S. Pat. No. 7,297,259).
3. Levison, P. W., 1994. “Mixing can having a hinged cap with an integral measuring cup”, (U.S. Pat. No. 5,295,610).
4. Arnott, B., 2006. “Method for removing oil spills”, (U.S. Pat. No. 7,041,221).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention/Technical Field

The following is ‘A statement of the field of art to which the invention pertains’:
1. U.S. Class 426 Field of Search: 426/113, 428/34.2, 428/34.3
2. U.S. Class 210 Field of Search: 210/242.3, 210/923
3. U.S. Class 222 Field of Search: 222/26, 222/157, 222/29, 222/468, 222/482, 73/427
4. U.S. Class 210 Field of Search: 210/660, 210/679, 210/680, 210/690, 210/922

2. Description of Related Art

Popa et al. (2010) describe the use of cyclodextrin incorporated with a film layer of packages to reduce the permeation of oil through the package material. Garcia (2007) describes a crude oil clean-up device attached to a ship and facilitates access to floating crude into a casing using a pair of arms coupleable to a side of a hull of a ship. Levison (1994) describe a plastic gas can for blending fuel mixtures. Arnott (2006) describe a method of using crushed glass to remove oil and oil contaminants from oil spills.

The prior inventions do not describe a massive enclosure used to enclose an entire large oil spill located in the Gulf of Mexico.

### BRIEF SUMMARY OF THE INVENTION

It is the objective of the invention to enclose the entire and large majority of the oil spill in the Gulf of Mexico to stop the movement of the large primary oil spill area, minimize the amount of oil potentially moving towards the coast, and minimize the general movement of the oil spill. The claimed invention provides a massive semi-permeable enclosure to be built around the major oil spill area from the upper surface of the Gulf down to the Gulf floor. The enclosure may extend above the upper surface and into the floor.

### BRIEF DESCRIPTIONS OF THE SEVERAL VIEWS OF THE DRAWINGS

The present invention will be more fully understood by references to the following brief description thereof when read in conjunction with the attached drawings, and wherein:

FIG. 1. A simple side view of the massive semi-permeable enclosure, 1, completely surrounding and enclosing all or the large majority of the oil spill in the Gulf of Mexico extending from the Gulf upper surface down to the Gulf floor.

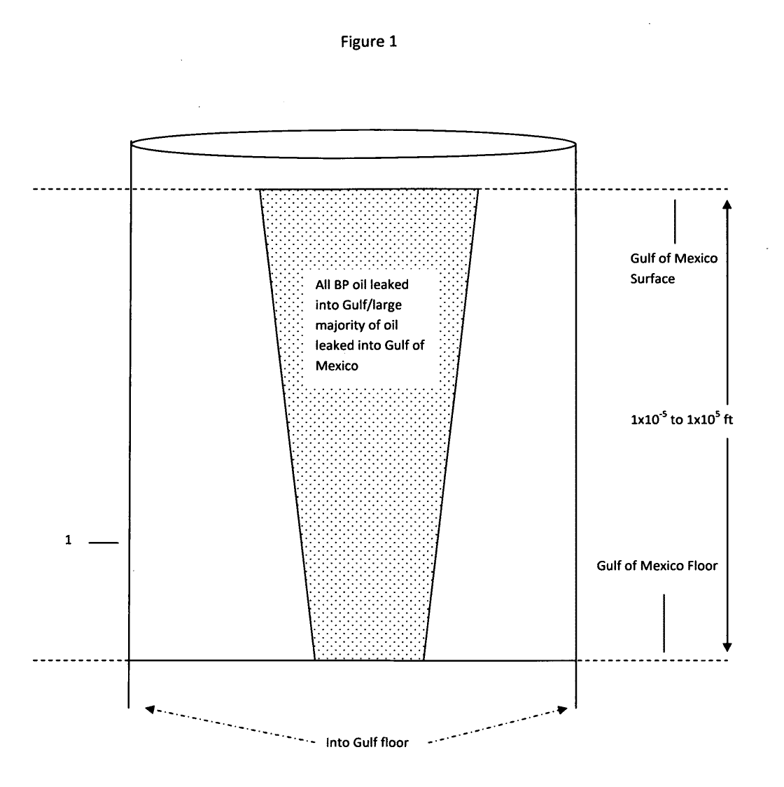

FIG. 2. A simple side view of a section of the massive semi-permeable enclosure depicting the semi-permeable area, 2, the strong, fortified, rigid and non-rigid enclosure section encasement area, 3, and of the oil processing and collection area, 4.

### DETAILED DESCRIPTION OF THE INVENTION

Present methods of reducing the impact of the oil spill in the Gulf of Mexico include such methods as stopping the leak at the source at the Gulf floor, blocking the oil on the Gulf, dispersants on the Gulf surface and in the Gulf, and removing the oil from the Gulf and coast. The present invention provides a method of massively enclosing the majority of the oil in the Gulf and hence stopping the major direct and extended impact of the Gulf oil spill. The massive enclosure provides oil and water permeability, oil and water chemical and physical processing, and oil and water collection. The enclosure is fortified and rigid and non-rigid, extends from 1×10⁻⁵ to 1×10⁵ feet to the Gulf floor, and the strong fortified exterior encases the permeable and chemical processing components. The invention may also be used to enclose particular oil spill areas of the Gulf.

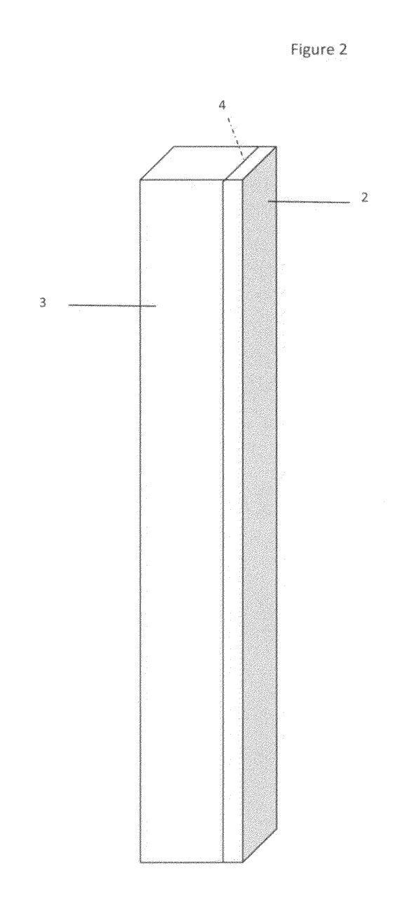

The massive enclosure, 1, is made by constructing 1×10⁻⁵ to 1×10⁵ feet vertical height, dependent on the depth of the Gulf floor at a given location of the enclosure extremities, by 1,000,000 feet wide, by 1,000,000 feet long circular enclosure around the oil spill in the Gulf of Mexico. The enclosure is circular or rectangular in shape, open in the center and location of the oil spill, with enclosure outer edges ranging in width of 0.0001-1,000 feet. The enclosure is constructed in as environmentally friendly as possible, with no negative nor short-term Gulf content, including salt, reaction, and with non-negative oil reaction. The enclosure is constructed by binding 100-1000 foot, 1-10 foot thick sheets of corrosion-resistant titanium, treated stainless steel, glass, alloys and other metal to form the numerous enclosure sections oil processing and collection area, 4. The 1-10 foot wide by 1-10 foot long chemical processing unit, 4, is attached to, and encased onto the outside face of the most interior surface of the titanium, treated stainless steel, and other metal sheet enclosure sections shown in FIG. 2. The semi-permeable membrane, 2, is bound to the inside surface of the chemical processing unit and is also encased by the titanium, treated stainless steel, and other metal sheet structure. The encasement sections of the enclosure allow the Gulf oil and water to come in contact with the semi-permeable membrane. These enclosure sections are bound together to form the massive enclosure, 1.

The massive enclosure, 1, and enclosure sections, 3, shown in FIG. 2 are also constructed by binding oil-resistant flexible non-metal materials strengthened with titanium, treated stainless steel, and other metal to form enclosure sheets, sheet sections and connecting units between the titanium, treated stainless steel, and other metal sheet and sheet sections. The flexible materials include those used to contain oil for collection, refining, and transportation, sale and research including plastics, aluminum, glass, alloys, and other metals.

The 1-100 foot wide by 1-100 foot long chemical processing unit, 4, is attached to, and encased onto the outside face of the most interior surface of the titanium, treated stainless steel, and other metal enclosure sheets. The chemical processing unit provides alkaline salt mixtures for combining with, and neutralizing oil passing through the semi-permeable membrane. The unit may also provide oil refining processes for oil collection and water processing for water collection. The 1×10⁻⁵ to 1×10⁵ feet vertical height of the chemical processing unit is dependent upon the depth of the Gulf floor.

The 1-100 foot wide by 1-100 foot long semi-permeable membrane component, 2, is attached to, and encased onto the outside face of the most interior surface of the chemical processing sections shown in FIG. 2. Semi-permeable membranes include ceramic, aluminum, other porous materials and techniques. The 1×10⁻⁵ to 1×10⁵ feet vertical height of the membrane component is dependent upon the depth of the Gulf floor.

I claim:

1. A method of making a massive enclosure device for enclosing the oil spill in the Gulf of Mexico comprised of:
making a 1×10⁻⁵ to 1×10⁵ feet vertical height by 1,000,000 feet wide by 1,000,000 feet long circular enclosure around the oil spill in the Gulf of Mexico,
making circular or rectangular enclosure in shape open in the center for location of the oil spill with enclosure outer edges ranging in width of 0.0001-1,000 feet

2. The method according to claim 1, wherein the massive enclosure is constructed in an environmentally friendly manner with no negative or short-term Gulf content reaction including salt reaction and with zero to minimum oil reaction.

3. The method according to claim 1, wherein the massive enclosure is constructed by binding 100-1000 foot by 1-10 foot thick sheets of corrosion-resistant titanium, treated stainless steel, glass, alloys and other metal to form numerous enclosure sections and oil processing and oil collection area.

4. The method according to claim 1, wherein the 1-10 foot wide by 1-10 foot long chemical processing unit is attached to and encased onto the outside face of the most interior surface of the titanium, treated stainless steel, and other metal sheet enclosure sections.

5. The method according to claim 1, wherein the semi-permeable membrane is bound to the inside surface of the chemical processing unit and is also encased by the titanium, treated stainless steel, and other metal sheet structure.

6. The method according to claim 1, wherein the encasement sections of the massive enclosure allow the Gulf oil and water to come in contact with the semi-permeable membrane.

7. The method according to claim 1, wherein the enclosure sections are bound together to form the massive enclosure.

8. The method according to claim 1, wherein the massive enclosure and enclosure sections are also constructed by binding oil-resistant flexible materials including plastics, aluminum, glass, alloys, and some metals strengthened with titanium, treated stainless steel to form enclosure sheets, sheet sections and connecting units between the titanium, treated stainless steel, and other metal sheet and sheet sections.

9. The method according to claim 1, wherein the flexible materials may include those used to contain oil for collection, refining, transportation, sale and research.

10. The method according to claim 1, wherein the 1-100 foot wide by 1-100 foot long chemical processing unit is attached to, and encased onto the outside face of the most interior surface of the titanium, treated stainless steel, and other metal enclosure sheets.

11. The method according to claim 1, wherein the chemical processing unit may provide alkaline salt mixtures for combining with, and neutralizing oil passing through the semi-permeable membrane.

12. The method according to claim 1, wherein the chemical processing unit may also provide oil refining processes for oil collection and water processing for water collection.

13. The method according to claim 1, wherein the 1×10⁻⁵ to 1×10⁵ feet vertical height of the chemical processing unit is dependent upon the depth of the Gulf floor.

14. The method according to claim 1, wherein the 1-100 foot wide by 1-100 foot long semi-permeable membrane component is attached to, and encased onto the outside face of the most interior surface of the chemical processing sections.

15. The method according to claim 1, wherein the semi-permeable membranes include ceramic, aluminum, other porous materials and techniques.

16. The method according to claim 1, wherein the 1×10⁻⁵ to 1×10⁵ feet vertical height of the membrane component is dependent upon the depth of the Gulf floor.
